(19) United States
(12) Patent Application Publication
(10) Pub. No.: US 2007/0105047 A1
(43) Pub. Date: May 10, 2007

(54) Record carriers and method for the production of record carriers

(75) Inventor: Sjoerd Stallinga, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,471

(22) PCT Filed: Dec. 7, 2004
(86) PCT No.: PCT/IB04/52696

§ 371 Date: Jun. 14, 2006

(30) Foreign Application Priority Data
Dec. 19, 2003 (EP) 03104857.2

(51) Int. Cl. G11B 7/24

(52) U.S. Cl. 430/270.11; 369/275.3; 369/275.4

(57) ABSTRACT

The invention comprises an optical record carrier comprising a data track, the data track including a sequence of marks and spaces of a plurality of different lengths. The marks and spaces form symbols encoding data. The length of each symbol comprises an integral multiple of a standard bit length, and an offset The offset of each symbol varies according to the nominal length of the symbol, and the nominal length of the neighboring symbol.

The invention relates generally to the field of record carriers. More specifically, the invention relates to optical record carriers having at least a portion of data that is read-only.

Optical record carriers are ubiquitous. Every year, millions of optical record carriers in the form of Compact Disc (CD) and Digital Versatile Disc (DVD) data storage media are sold all over the world. Optical record carriers combine light weight, small size, high data capacity, fidelity, ease of storage, and durability. Optical record carriers are by far the dominant form of media encoding film, music and data. A recent innovation is the development of a new format for optical record carriers known as the Blu-Ray™ Disc (BD) standard.

Optical record carriers fall into one of several categories, including read-only (readable, but not writeable), recordable (writeable one time only) and re-writeable (write, erasable, re-writeable). When the optical record carrier is an optical disc, each of the afore-mentioned types of optical record carrier undergoes a manufacturing process that creates at least one track in a data storage layer in the disc. For each type of disc, data is placed onto the track; the way in which data is so placed depends on the type of disc.

Read-only optical discs typically hold data in the form of a relief structure. The, or each, data track comprises a plurality of marks which are spaced irregularly with respect to one another. Since the marks constitute areas of a different depth in the disc to the intervening lands in the disc, the marks and spaces form a relief structure in a data storage layer of the disc. The lengths of the marks and spaces, which are collectively referred to as the symbols, encode digital data. Read-only optical discs are typically formed by a molding process using a mould referred to as a ‘stamper’ or ‘master.’ The manufacture of the stamper is referred to as a mastering process, and is described in more detail below.

Once the stamper is produced, a substrate layer, made of, for example polycarbonate, is produced from it. The information on an optical disc is encoded as a sequence of symbols (marks and spaces) molded into the top of the polycarbonate layer which has a reflective coating. The length of the symbols on read-only discs is an integer number times a unit length, the standard bit length. The integer corresponds to the so-called ‘nominal length’ of the mark. A nominal length of 3 for a symbol indicates that the symbol is three times the length of a standard bit length. The integer number used to determine the lengths of marks and spaces can take values between d+1 and k+1. In the case of the Blue Ray Disc (BD) standard, d=1 and k=7.

In the case of a CD, each mark is approximately 125 nanometers deep by 500 nm wide, and varies from 850 nm to 3.1131 μm long, depending on the integer length. The spacing between the tracks is 1.5 μm. In the case of BD, the marks are much smaller, having a width of around 140 nm, a depth of around 63 nm, and a length varying from 150 nm to 600 nm depending upon the integer length.

All optical discs are read by aiming a laser beam at the disc and monitoring the reflected beam. Light from a semiconductor laser is shone through a transparent layer, and the light reflected by the reflective data storage layer is monitored. The light from the laser forms a spot on the reflective data storage layer. The light beam is shone through a relatively thick substrate layer of the disc in the case of CD discs, and through a relatively thin cover layer of the disc in the case of BD discs. The area of the data layer without marks is known as “land” and marks may be referred to as “pits”.

Light striking the “land” areas is reflected normally and detected by a photodiode. Light striking a mark, however, undergoes destructive interference with light reflecting from the land surrounding the bump and no light is reflected. This occurs because the depth of each mark is one quarter of the wavelength of the laser light (in the transparent layer through which the beam is focused), leading to a half-wavelength phase difference in light reflecting from the land to that of light reflecting from the mark.

It is the object of this invention to improve the quality and fidelity of data read-out from optical record carriers, reducing the variation between input and output data (data stamped onto the disc during manufacture, and data read out by an optical scanning device).

In accordance with one aspect of the present invention, there is provided an optical record carrier, the optical record carrier comprising a data storage layer including a relief structure for storing data to be read, wherein the relief structure comprises a data track encoding data which is read-only, the data track comprising: a sequence of symbols having nominal lengths corresponding to an integral multiple of a standard bit length, the symbols having edges positioned according to a set of reference points which are regularly spaced along the data track and separated by the standard bit length, wherein the data track includes a first such edge, wherein the first edge is shifted along the data track, with respect to one of said reference points, by a first offset, wherein the data track includes a second such edge, wherein the second edge is shifted along the data track, with respect to another of said reference points, by a second offset, wherein the magnitude of the second offset is different to the magnitude of the first offset.

As described above, the marks and spaces in the data storage layers of optical record carriers encode data according to their length. When the read-out signal from an optical record carrier is analyzed, the output value calculated from the length of the symbols, as derived from the read-out signal, is not always equal to the intended input value of the mark or space, represented by the nominal length of the mark or space. A mark of nominal length of 4 may be read out as a mark of length 3.8 or length 4.2, for example, even though the mark stamped onto the disc is of a length that exactly correlates with a nominal integer value of 4. In particular, marks and spaces with a nominal length of 3 are often read out as being too long (marks and spaces of nominal length 3 give output values of greater than 3). These are systematic read-out bit length errors, and they cause the output signal from the disc to differ from the intended signal, degrading output signal quality.

The incorporation of varying offsets into the positioning of the edges of the symbols provides a solution to the problem of read-out bit length errors. Offsets change the physical position and length of the symbols on the carrier, shifting the border between a mark and a space. If offsets according to an embodiment of the invention are incorporated, systematic read-out errors are compensated for, and read-out data quality and fidelity improved, with no need to alter existing reading equipment. By altering the physical length of symbols in the relief structure of the carrier, read-out error rates can be significantly reduced. In an embodiment of the invention, one of the symbols has a centrepoint halfway along its nominal length, and the centrepoint is shifted with respect to a regularly spaced reference point by an offset. In this way, a symbol may be shifted both in terms of its edges and its center (i.e. moving the symbol as a whole.)

Preferably, the data track includes a first symbol and a second symbol, the first symbol having a first nominal length, the first nominal length corresponding to a first integral multiple of the standard bit length, the second symbol having a second nominal length, the second nominal length corresponding to a second, different, integral multiple of the standard bit length, wherein said first symbol includes said first edge and wherein said second symbol includes said second edge.

The first symbol may have a third edge which is shifted with respect to a position defined by the standard bit length, by a third offset. Both or either edge of a symbol may be shifted by an offset in order to improve read-out data quality. The offsets may be the same, or they may differ.

Although two symbols may be of the same nominal length, the offsets of the two symbols may differ. Offsets may be calculated according to both the nominal length of a symbol and the nominal length of another, neighboring symbol. Accordingly, if the sequence comprises a third symbol having the same nominal length as the second symbol, and the third symbol has an edge shifted by a fourth offset, the fourth offset may be different to the second offset.

The sequence may be arranged such that the second symbol is systematically presented adjacent to one or more further predetermined symbols, and the third symbol is systematically presented adjacent to one or more different further predetermined symbols. In a sequence, there may be certain systematic patterns of symbol nominal length, and symbols of a given nominal length may appear more frequently than symbols of other nominal length. An edge of a symbol may be offset by a value depending on the nominal length of one or more of the symbols adjacent to the edge. Symbols of a certain nominal length have been found to be more prone to read-out error than others, in particular when followed by, or preceded by, a symbol of a certain different nominal length. For example, an edge may be shifted by an offset having a magnitude of between 5% and 15% of the standard bit for a symbol of nominal length 3, in particular when it is followed by, or preceded- by, a symbol of nominal length 2.

In accordance with a further aspect of the present invention, there is provided a method of manufacturing an optical record carrier comprising a data storage layer, the method comprising: writing digital data to a surface, the writing comprising forming a data track including a sequence of symbols having nominal lengths corresponding to an integral multiple of a standard bit length, the symbols having edges positioned according to a set of reference points which are regularly spaced along the data track and separated by the standard bit length, wherein the sequence of symbols includes a first such edge, wherein the first edge is shifted along the data track, with respect to one of said reference points, by a first offset, wherein the data track includes a second such edge, wherein the second edge is shifted along the data track, with respect to another of said reference points, by a second offset, wherein the magnitude of the second offset is different to the magnitude of the first offset.

The method in accordance with an aspect of the present invention provides for the manufacture of a stamper. This stamper may then be used to produce optical carriers comprising a sequence of symbols according to an embodiment of the invention, the offsets in the sequence of symbols providing the improvement in read-out quality described above. In an embodiment, the offsets are determined with reference to a look-up table, thereby facilitating the process of offset calculation. The table may take into account one or more nominal lengths for each offset.

Further features and advantages of the invention will become apparent from the following description of preferred embodiments of the invention, given by way of example only, which is made with reference to the accompanying drawings in which

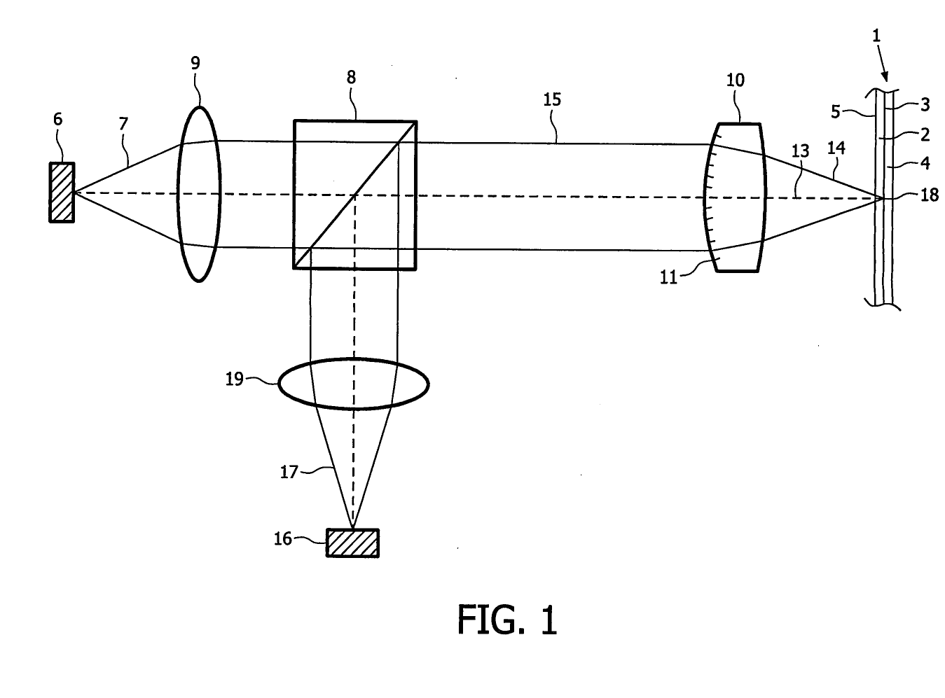

FIG. 1 is a schematic diagram showing an optical scanning device operating in conjunction with an optical record carrier according to an embodiment of the present invention,

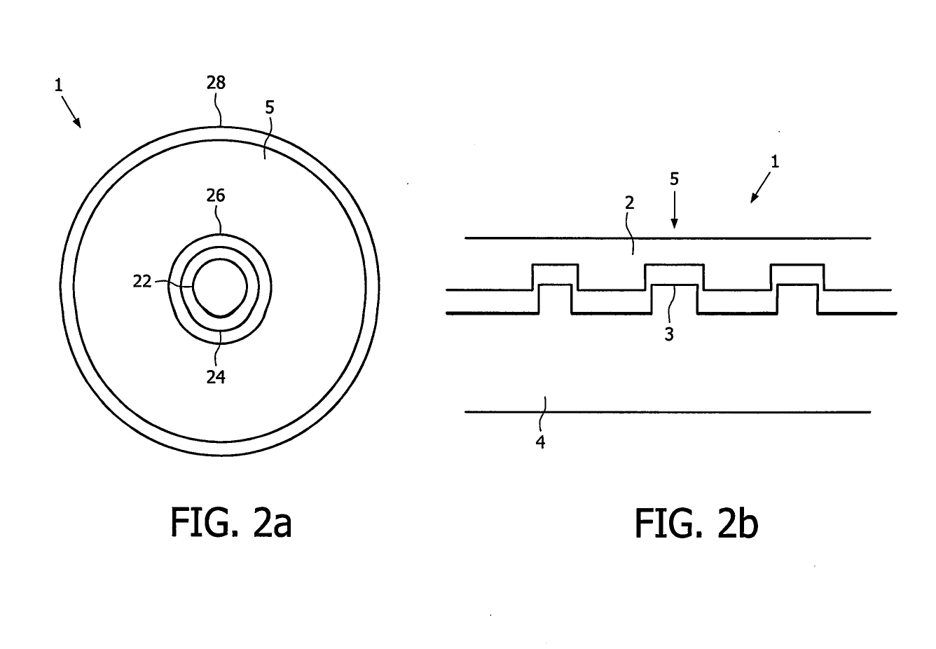

FIGS. 2a and 2b show an optical record carrier according to an embodiment of the present invention,

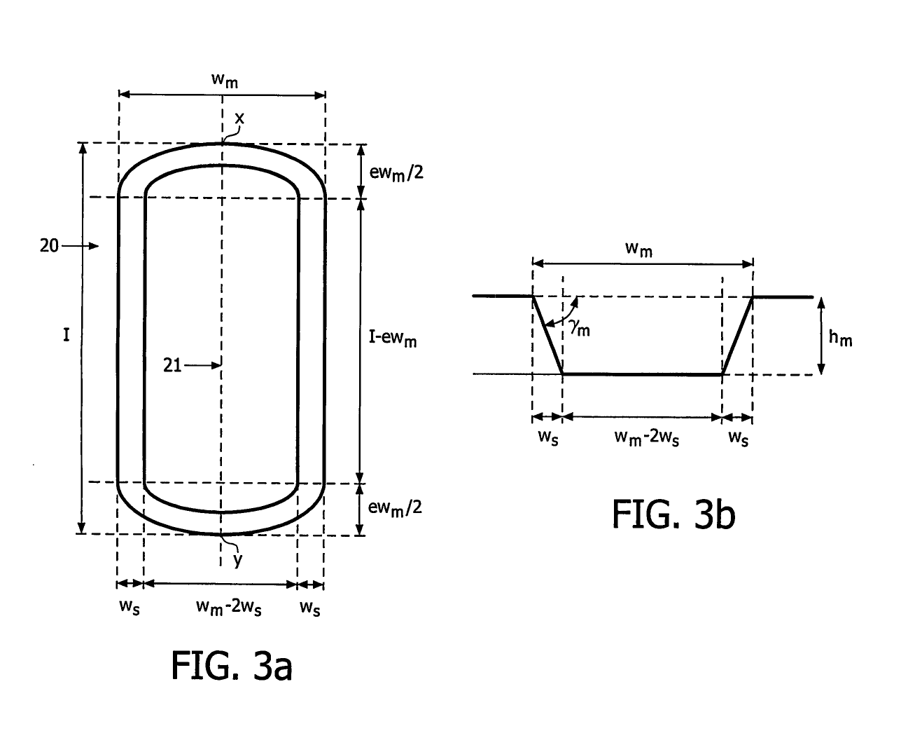

FIGS. 3a and 3b show a mark in the data storage layer of the optical record carrier, in plan view and cross-section respectively,

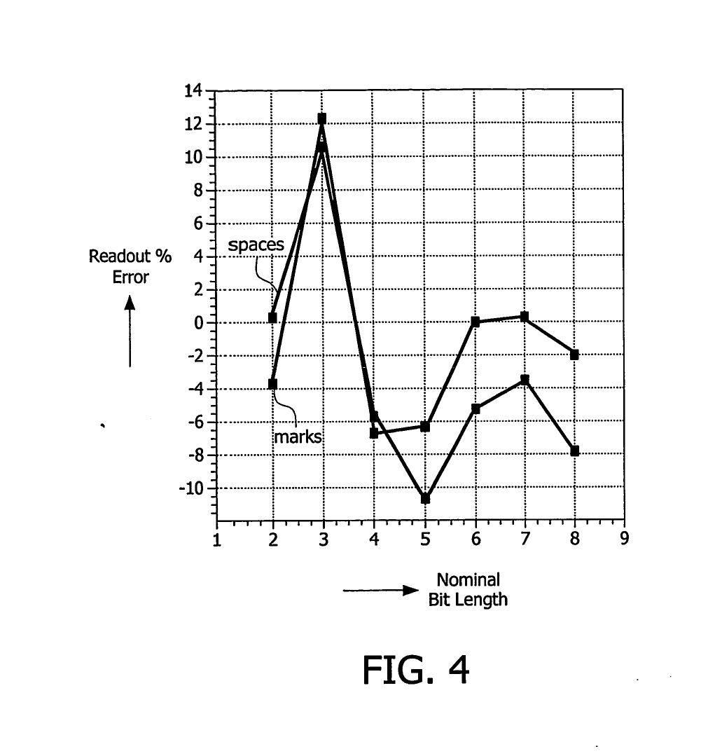

FIG. 4 shows read-out errors that have been detected from analysis of simulated read-out data based on known optical record carriers,

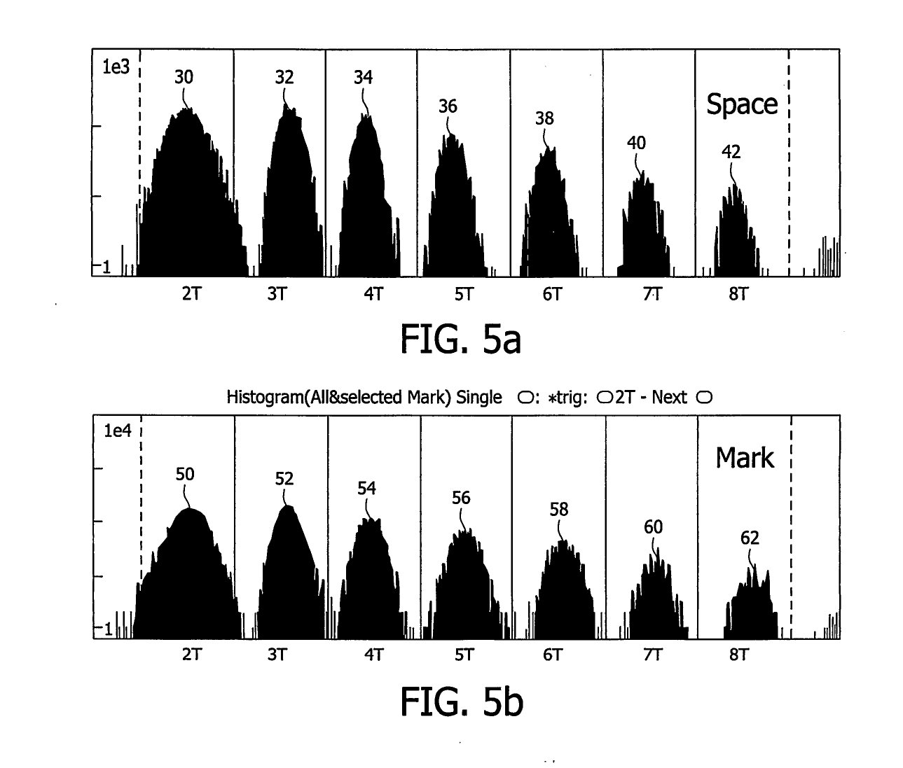

FIGS. 5a and 5b are histograms showing measured read-out data from the known optical record carriers, illustrating the deviation in read-out data from the nominal integer values of symbols,

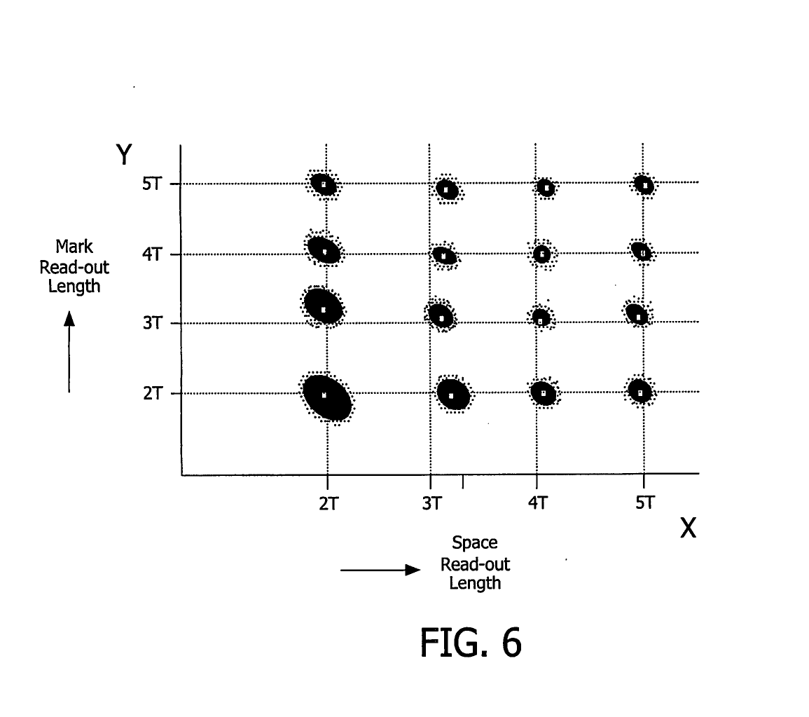

FIG. 6 is a deviation matrix showing measured inter-symbol interference,

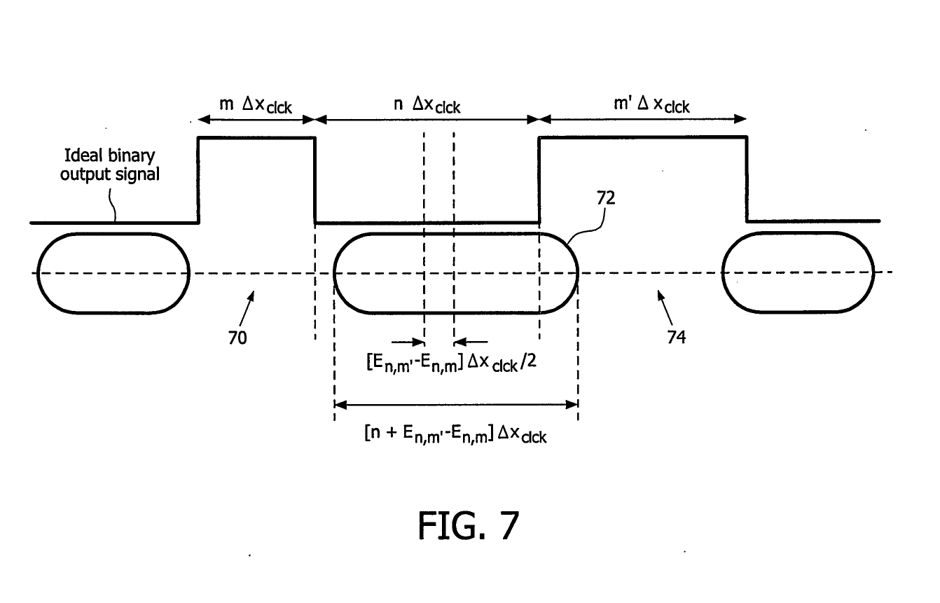

FIG. 7 shows a sequence of marks and spaces in the data storage layer of an optical record carrier in accordance with an embodiment of the invention,

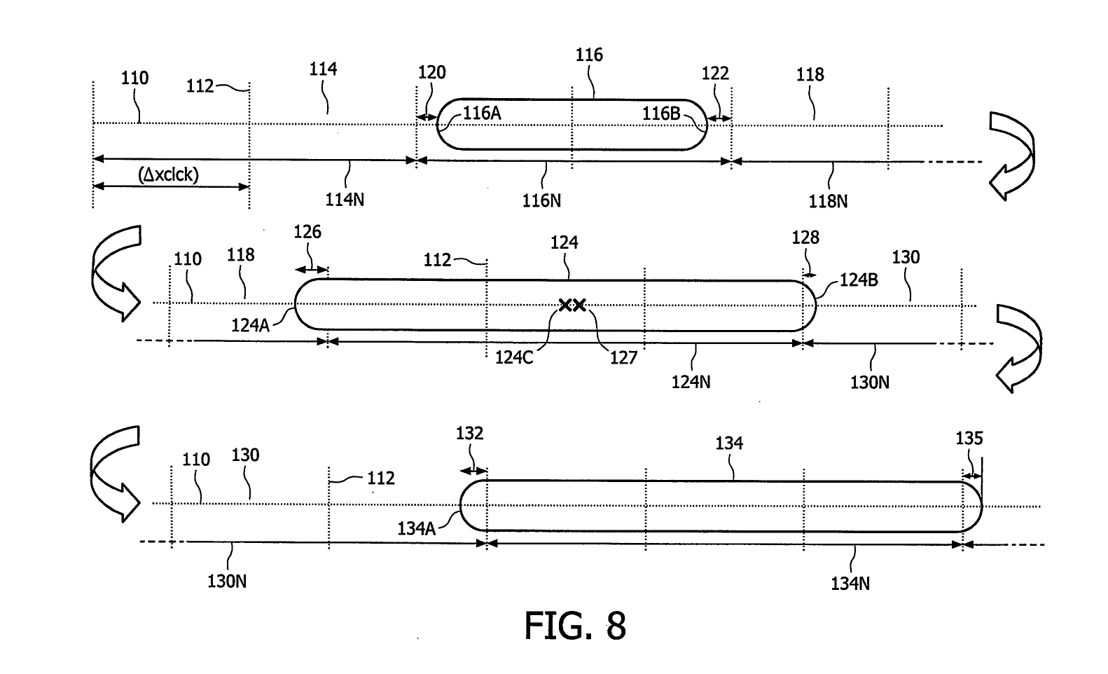

FIG. 8 shows a further sequence of marks and spaces in the data storage layer of an optical record carrier in accordance with an embodiment of the invention,

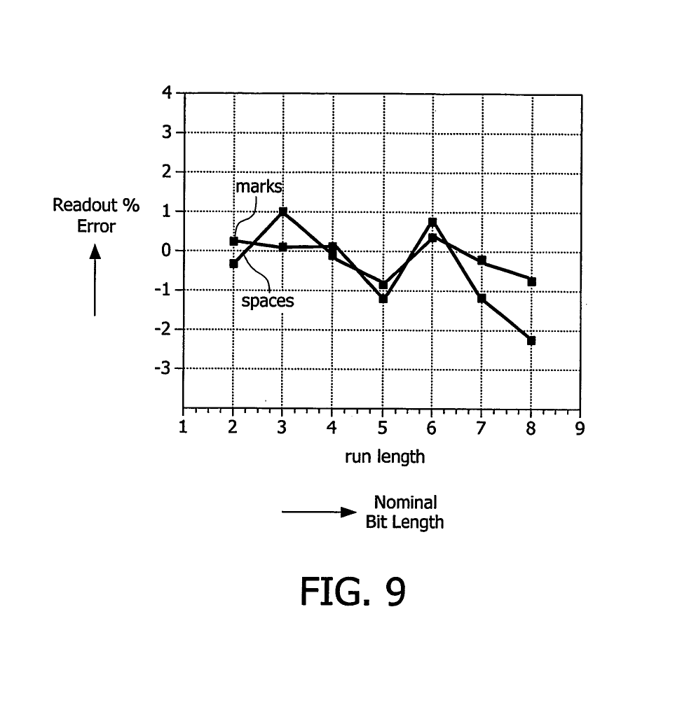

FIG. 9 is a graph showing the read-out errors detected from analysis of the simulated read-out data of an optical record carrier comprising a sequence of marks and spaces in accordance with an embodiment of the invention,

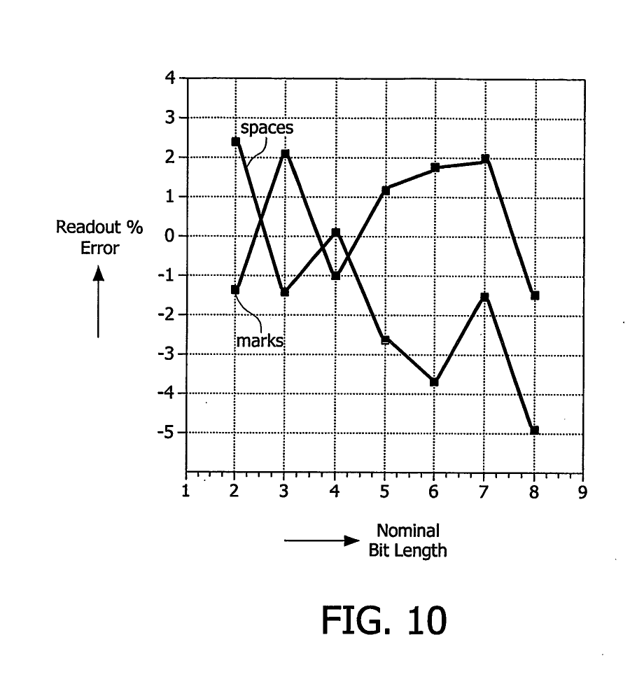

FIG. 10 is a further graph showing the read-out errors detected from analysis of the simulated read-out data of an optical record carrier comprising a sequence of marks and spaces in accordance with a second embodiment of the invention, and

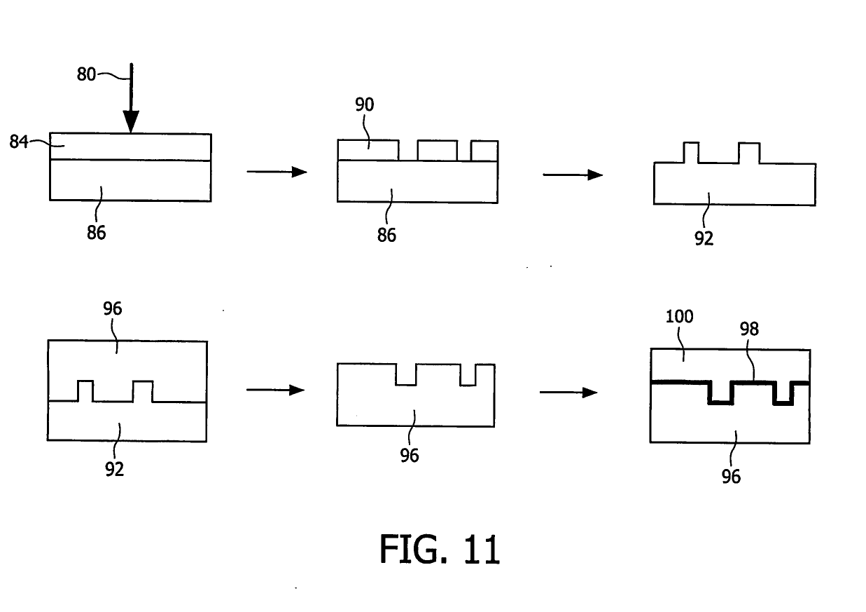

FIG. 11 illustrates a method of manufacturing an optical record carrier according to an embodiment of the invention.

FIG. 1 shows a schematic diagram of an optical scanning device with which optical record carriers in the form of discs according to embodiments of the present invention are arranged to operate. The optical scanning device includes a radiation source 6, for example a semi-conductor laser, emitting a diverging radiation beam 7. A beam splitter 8, for example a semi-transparent plate, is arranged to transmit the diverging beam 7 towards an objective lens 10. The lens system includes a collimator lens 9 and an objective lens 10 arranged along an optical axis 13.

The collimator lens 9 is arranged to transform the diverging beam 7 emitted from the radiation source 6 into a substantially collimated beam 15. The objective lens 10 is arranged to transform the incident collimated radiation beam 15 into a converging beam 14, having a selected numerical aperture (NA), which comes to a spot 18 on a layer of optical disc 1 (specifically data storage layer 3, described in more detail below). A detection system 16 and a second collimator lens 19, together with the beam splitter 8, are provided to detect a main information signal and focus and tracking error signals, which are used to mechanically adjust the axial and radial position of the objective lens 10.

The optical disc 1 may have a single data storage layer (a so-called ‘single-layer’ disc) or multiple data storage layers (a so-called ‘multi-layer’ disc.) An embodiment of single layer disc 1 is shown in more detail in FIGS. 2a and 2b. FIG. 2a shows an optical record carrier according to an embodiment of the invention, in the form of a read-only disc conforming to the BD standard (herein referred to as BD-RO). Disc 1 has an aperture 22, surrounded by a clamping area 24, which fits into a mechanism (not shown) to rotate the disc. Entrance face 5 is shown. The spiral track of symbols in the data storage layer (shown in FIG. 2b) originates at lead-in area 26 and ends near the edge of disc 1 at lead-out area 28.

Disc 1 is made up of a number of layers in cross-section, shown in more detail in FIG. 2b. Optical disc 1 comprises a transparent layer 2, which has entrance face 5 of the disc on one side and at least one data storage layer 3 on the other side. The transparent layer 2 essentially presents a refractive carrier for the converging beam 14 to pass through. The data storage layer, or layers, are in turn arranged on supportive substrate 4. The data storage layer 3 includes a reflective layer in its upper face, facing away from the transparent layer, forming a relief structure. The relief structure comprises data tracks made up of a sequence of marks and spaces. The relief structure is formed in the data storage layer during the mastering process, which is described in more detail below.

In the case of a multi-layer disc, two or more data storage layers are arranged behind a first transparent layer, and a data storage layer is separated from another data storage layer by a further transparent layer. Each data storage layer is located at a different depth within the disc with respect to the entrance face 5.

FIGS. 3a and 3b show a mark 20 of a so-called ‘stadium’ shape which forms part of the relief structure in the data storage layer 3 of disc 1. The mark is formed in the data storage layer 3 of the optical record carrier 1 by stamping the layer with a surface known as a stamper formed from a ‘master’ (which process is described in more detail below.)

FIG. 3a shows a plan view of the mark. The mark forms a height profile in the surface of the data storage layer. The physical length of the mark 20 (l), as physically stamped into the disc at the time of manufacture, is measured along the centerline 21 of the mark, between its leading and trailing edges (from point x to point y). The total length l includes the two caps ewₘ/2 and the central portion l-ewₘ. The length l of the mark 20 comprises an integral multiple of the standard bit length, which multiple corresponds with the nominal length, and further may comprise an offset (which may be zero).

The standard bit length is the base unit of data for a record carrier, and depends upon the type of the record carrier. In the case of a BD-RO with a capacity of around 25 GBytes, the standard bit length is 75 nm. The nominal length for marks and spaces can take values between d+1 and k+1, where d=1 and k=7. Therefore, the available integers for marks and spaces on a BD-RO are 2, 3, 4, 5, 6, 7, and 8. The width, depth and wall angle (wₘ, hₘ, γₘ) of all the marks on a BD-ROM are substantially identical - information is encoded in the length of the mark. FIG. 3b shows mark 20 in cross-section, illustrating the depth hₘ and wall angle γₘ of the mark. The data storage layer 3 of disc 1 shown in FIGS. 1, 2a and 2b comprises a multiplicity of marks such as mark 20, in data tracks separated by a constant distance.

The spaces between the marks also encode data by nominal length in the same way as marks. The length of a space is measured along the same centerline as the marks, from the trailing edge of the last mark in sequence to the leading edge of the next.

FIG. 4 is a graph showing simulated read-out percentage error of the known optical record carrier. The data is derived from statistical analysis of the simulated read-out from a BD-RO with a plurality of symbols. BD-RO symbol lengths in the simulation have the same frequency and distribution as the symbols in the data storage layer of real prior art BD-ROs. The read-out percentage error on the y axis is plotted against the bit length of each symbol. Marks and spaces are plotted on separate lines, as indicated. It can be seen that marks and spaces are both subject to a roughly similar pattern of percentage errors at most bit lengths. Inaccuracy in read-out symbol length leads to a loss of data quality, as the intended value of the symbol will not form part of the output from the disc.

The percentage error is derived from the deviation in average bit read-out length compared to the nominal length for all symbols. The percentage deviation is the percentage of a standard bit length. Symbols of nominal length 2 are read out on average as 2% of a standard bit length too short—marks are 4% too short and spaces are on average read out accurately (0% average space error). Symbols of bit length 3, by contrast, are, on average, between 10 and 12% too long; spaces are just over 10% too long, while marks are 12% too long. Symbols of nominal length 4 are around 6% too short at read-out. At nominal lengths of 5 and above, spaces and marks show differing percentage error but follow a similar pattern. This particular pattern of error is characteristic of the symbol parameters of BD-ROs. Other optical record carriers will have a differing pattern of read-out percentage error.

FIGS. 5a and 5b are histograms showing measured read-out data from a known BD-RO illustrating the deviation in read-out data from the nominal symbol bit values. The vertical axis represents the number of symbols read out and the horizontal axis represents the bit length of the symbols as read out. The dashed lines represent the points on the x axis that correspond to integer bit values.

FIG. 5a shows the histogram for spaces. It can be seen that, around the point on the horizontal axis corresponding to a bit length of 2, there is a wide frequency distribution 30, and therefore considerable variation in read-out length for spaces of a nominal length of 2. Although the peak of distribution 30 is centered at the dashed line indicating read-out bit length 2, the distribution 30 is slightly right-skewed, with a small but appreciable amount of spaces read out as having a bit length of around and over 2.5. This indicates that spaces of a nominal length of 2 vary considerably in length when read out. There will therefore be a considerable amount of error in a dataset comprising a high frequency of symbols of a nominal length of 2.

The peak of frequency distribution 32 is centered slightly to the right of bit length 3, indicating that spaces of a nominal length of 3 are generally read out as being slightly too long. However, the width of the distribution 32 is narrower than the width of distribution 30, indicating that nominal length 3 spaces are less likely to vary in value from 3 in read-out bit length There are also discernible patterns at higher bit lengths. Distributions 34, 36, and 38 indicate that spaces of nominal length 4, 5, 6 or 7 are usually read out as being slightly too short. Distribution 42 does not clearly indicate a pattern of read-out error due to a paucity of data

Similar patterns may be discerned from the histogram of mark read-out frequency shown in FIG. 5b. Distribution 50 peaks at a read-out length of 2, but is very wide, with tails around 1.5 and 2.5, indicating a similar variation in the read-out data of marks and spaces of a nominal length of 2. No other distribution in FIG. 5b is as wide as distribution 50, and a similar decrease in the frequency of marks with length can be seen. Like distribution 32, distribution 52 is centered slightly to the right of a bit length of 3, indicating a tendency in read-out to increase the bit length of marks of a nominal length of 3. Distributions 54, 56, 58, 60 and 62 indicate that marks of nominal lengths of 4 and above are usually read accurately as the peaks of all those distributions are centered around the integers of their nominal read-out length.

It can also be seen from the histograms that symbol bit length frequency decreases with length; there are more symbols of lower bit length than higher. Distributions 42 and 62, indicating the read-out lengths of spaces and marks of a nominal length of 8, are far smaller and less dense than any other distribution in FIGS. 5a and 5b, indicating that symbols of a nominal length of 8 are the least frequent. On the other hand, the most common symbols are those of nominal length 2, as indicated by the width and height of distributions 30 and 50. Both graphs indicate that symbols of shorter nominal length are both the most frequent and the most prone to read-out error and therefore the quality of the data at read-out is very likely to be compromised.

FIG. 6 is a graph showing how read-out errors of neighboring symbols affect each other, in the form of a set of dots each representing a measured read-out of a combination of a mark and a space, the read-out length of the mark given on the y axis and the read-out length of the space given on the x axis. The dots form spreads around the intersections of integer values, where the integer values are shown in dashed lines. A small white square is shown at each intersection of nominal length values, to indicate the average read-out value for each combination. It can be seen that a particularly high deviation is seen where one symbol is of nominal length 3 and the other is of nominal length 2, the center of the spread is off the intersection line where the nominal integer values meet. Therefore, it would appear that neighboring symbols of nominal length 2 and 3 have an effect on each other, causing more read-out error than any other combination of symbol bit lengths. This effect may be termed length-dependent inter-symbol interference, because the read-out error detected for a symbol varies according to the length of the symbol and a neighboring symbol.

FIG. 7 shows an ideal binary output signal from an optical record carrier, and a sequence of marks and spaces in the data storage layer of an optical record carrier, in accordance with an embodiment of the invention. The sequence of marks and spaces comprises a space 70, a mark 72 and a space 74. Space 70 has a nominal run length m, mark 72 has a nominal run length n, and space 74 has nominal run length m′, where n, m, and m′ are integers taking values from d+1 to k+1. As noted above, according to the BD standard the integers would therefore be 2-8. The standard bit length is ΔX_{clck}. E_{n,m} is the offset, which is the linear shift of the edge between a mark and a space. The offset may also cause a shift in the position of the center of a symbol.

Ideally, the output signal as read-out by the optical scanning device will be as similar as possible to the input signal. In known optical record carriers, marks and spaces are stamped into the disc in a pattern that exactly reflects the binary input signal in linear terms. Due to the systematic errors described above, the output signal from a known disc will vary from the intended input signal.

In an optical record carrier according to an embodiment of the present invention, the edges between marks and spaces are shifted by an offset distance, in comparison with the marks and spaces found in the prior art. In comparison with lengths corresponding to the ideal binary output signal, the edge between the space 70 and the mark 72 is shifted by an offset distance E(_{n,m})Δx_{clck} to the left, and the edge between mark 72 and the space 74 is shifted over a distance E(_{n,m})Δx_{clck} to the right. The position of the center of mark 72 is then shifted over a distance [E(_{n,m′})−E(_{n,m})]Δx_{clck}/2 to the right. The mark 72 has a total length l=[n+E_{n,m′}+E_{n,m}]Δx_{clck}. The physical length of mark 72 is therefore increased by [E(_{n,m})+E(_{n,m′})]Δx_{clck} compared to an integral multiple of the standard bit length interval. When the marks and spaces shown in FIG. 7 are scanned and read-out, the output signal will be an improved match to the ideal binary output signal.

By altering the length and center position of the symbols on the record carrier, systematic read-out errors are compensated for, and read-out data quality and fidelity improved, with no need to alter existing reading equipment By altering the record carrier, the data as read-out will more accurately reflect the intended binary output signal.

The read-out signal can be optimized by varying the offsets E(_{n,m}) for all nominal lengths (values of n and m). Table 1 shows length offsets for a combination of each mark and space combination, as a fraction of standard bit length, for a BD-RO in accordance with an embodiment of the invention. The offsets have been determined by simulation to optimize read-out quality.

TABLE 1

| | Space | | | | | | |
|---|---|---|---|---|---|---|---|
| Mark | 2 | 3 | 4 | 5 | 6 | 7 | 8 |
| 2 | 0.0131 | 0.0619 | −0.0149 | −0.0293 | −0.0087 | −0.0097 | −0.0058 |
| 3 | −0.0646 | −0.0074 | −0.0860 | −0.1036 | −0.0834 | −0.0745 | −0.0876 |
| 4 | 0.0396 | 0.1006 | 0.0190 | −0.0025 | 0.0228 | 0.0228 | 0.0038 |
| 5 | 0.0234 | 0.0923 | 0.0100 | −0.0129 | 0.0142 | 0.0179 | 0.0045 |
| 6 | −0.0011 | 0.0610 | −0.0194 | −0.0434 | −0.0197 | −0.0175 | −0.0319 |
| 7 | 0.0038 | 0.0678 | −0.0158 | −0.0390 | −0.0110 | −0.0091 | −0.0280 |
| 8 | 0.0047 | 0.0719 | −0.0132 | −0.0317 | −0.0096 | −0.0152 | −0.0156 |

Note that the sign convention used in Table 1 (and Table 2, set out below) is such that the positive direction is always the direction, at the edge between a mark and a space, which goes from the space towards the mark (referred to herein as “the direction of the mark”). Each entry in Table 1 determines how the edge between the corresponding mark and space combination should be offset in the direction of the mark. The magnitude of the offset is thus varied according to the nominal length of the mark and the nominal length of the space, which are adjacent to each side of the edge.

For example, a sequence may consist of a mark of nominal length 4, a space of nominal length 2, a mark of nominal length 3, and a space of nominal length 4. The edge between the mark of nominal length 4 and the space of nominal length 2 is shifted by an offset of 0.0396 (i.e. it is shifted by +3.96% of the standard bit length in the direction of the mark, or −3.96% of the standard bit length in the direction of the space). The edge between the space of nominal length 2 and the mark of nominal length 3 is shifted by an offset of −0.0646 (i.e. it is shifted by −6.46% of the standard bit length in the direction of the mark, or +6.46% of the standard bit length in the direction of the space). The edge between a mark of nominal length 3 and a space of nominal length 4 is shifted by an offset of −0.0860 (i.e. it is shifted by −8.60% of the standard bit length in the direction of the mark, or +8.60% of the bit length in the direction of the space). It can be seen that the value of the optimal offset varies depending on the respective lengths of the mark and space, in order to compensate for the length-dependent inter-symbol interference described above with reference to FIG. 6.

FIG. 8 shows a portion of a data track on an optical record carrier comprising a sequence of symbols according to an embodiment of the invention. FIG. 8 is diagrammatic only, and is not to scale. One data track, read from right to left, is shown, in three sections. A scanning device projects a scanning light beam along data track 110, represented by its center line. The dashed vertical dividing lines 112 show how the data track is divided into regular, standard bit length distances, forming regularly spaced reference points. Three marks (116, 124, 134) and three spaces (114, 118 and 130) are shown.

The length of a standard bit length (Δx_{clck}) is shown in FIG. 8, as the distance between each of a set of standard reference points 112. The reference points 112 are regularly spaced along the data track with a spacing corresponding to the standard bit length (Δx_{clck}). Symbols on the data track are placed with the positions of their edges determined according to the reference points 112, and with given offsets. The nominal length of each symbol is shown in FIG. 8 in terms of the corresponding integral multiples of the standard bit length distance, given by the reference numeral followed by N.

Space 114 is made up of a nominal length of 2, as shown beneath the space (distance 114N). The nominal lengths of all the symbols in the data track of FIG. 8 are shown by the measurements represented by horizontal arrows beneath the symbols. Following the space 114, the mark 116 has a nominal length of 2 (measurement 116N), and edges 116A and 116B.

In accordance with an embodiment of the invention, the edges of the mark 116 are shifted by an offset. According to Table 1, the optimal offset between a space of length 2 (here, space 114) and a mark of length 2 is 0.0131, or 1.31% of the standard bit length, in the direction of the mark. The edge 116A of mark 116, between space 114 and mark 116, is therefore shifted by this distance, shown as offset 120. Space 118 is also of nominal length 2 (measurement 118N). The edge 116B of mark 116, between mark 116 and space 118, is therefore similarly shifted by 1.31% in the direction of the mark, shown as offset 122. It can be seen, therefore, that, according to an embodiment of the invention, the edges of a symbol may have two similar offsets, if the symbol is preceded and followed by symbols of a similar length.

Mark 124 has a nominal length of 3 (shown by measurement 124N). Referring again to Table 1, the edge 124A between space 118 and mark 124 is shifted by −0.646, or −6.46% in the direction of the mark, shown as offset 126. The edge 124B of the mark 124, between the mark 124 and the space 130 (of nominal length 3) is shifted by −0.0074, or −0.74% of standard bit length in the direction of the mark, shown as offset 128. Offsets 126 and 128 vary (−0.646, or −6.46%, and 0.0074, or 0.74%). It can be seen, therefore, that the edges of a symbol may have different offsets where the preceding and following symbols have different lengths.

Space 130 has a nominal length of 3 (measurement 130N), and is followed by mark 134, which also has a nominal length of 3 (measurement 134N). According to Table 1, therefore, offset 132 is −0.0074 or 0.74% in the direction of the mark. In this case, it can be seen, therefore, that symbols of similar nominal length may have different offsets, depending upon the nominal length of neighboring symbols. The mark 124 and mark 134 both have a nominal length of 3, however, the values of the offsets vary—in this example, offset 126 is −0.646, or −6.46% of a standard bit length, while offset 132 is −0.0074 or 0.074%, due to the differing lengths of the symbols preceding the marks. Mark 134 has a further offset 135, although the following space is not shown. The length of offset 135 would vary according to the length of the following space.

Due to the fact that the offset on each side of a symbol may be different, the center of the symbol, defined as the point halfway along its length, may also be shifted relative to the centrepoint of the symbol's nominal position, referred to herein as a reference centrepoint. Reference centrepoint 124C is positioned halfway along the nominal length of mark 124, i.e. halfway along measurement 124N. However, the actual center point 124C of mark 124 is shifted relative to reference centrepoint 127, due to the offsetting of edges 124A and 124B. Therefore, it can be seen that offsets alter the length and centrepoint of symbols as a whole.

It will be understood that FIG. 8 is illustrative only, and that the invention is not limited in any way to the specific example shown therein. The invention may be applied to sequences of any length, and of any combination of symbols.

FIG. 9 is a graph showing simulated read-out percentage error of an optical record carrier comprising a sequence of marks and spaces in accordance with the first embodiment of the invention. Optimized offsets as shown in Table 1 have been incorporated in the symbols, and the read-out percentage error in comparison to input data is plotted against nominal length. Marks and spaces are plotted separately. The error fluctuates between +1 and −1% for nominal lengths of up to 6 for both marks and spaces.

Comparison of FIG. 9 with FIG. 4 shows that read-out percentage error is reduced for most nominal lengths when optimized offsets are incorporated into the symbols on an optical record carrier. Most significantly, it can be seen that read-out percentage error for symbols of nominal length 3 is 1% for spaces and nearly zero for marks. As noted above with reference to FIG. 4, error at nominal length 3 is particularly high for the known BD-RO. This source of error is greatly reduced when optimized offsets according to an embodiment of the invention are incorporated into an optical record carrier.

Simulations of an optical record carrier without optimized symbol offsets show that the data to clock jitter, a measure of error of read-out data in comparison with input data, is 6.2%. The simulation does not incorporate a number of noise sources, so this measure should be seen as a lower bound for the actual data to clock jitter number. If an identical simulation is run incorporating optimized offsets as shown above in Table 1, data to clock jitter is 3.6%. The incorporation of offsets according to an embodiment of the invention therefore significantly reduces read-out error.

Offsetting the position of the edge between symbols greatly improves read-out quality even when the offset is not totally optimal. It can also be shown by simulation that non-optimal, or ‘simplified’, offsets also greatly reduce read-out error. A set of simplified offsets, also for a BD-RO, in accordance with a second embodiment of the invention, are shown in Table 2. The simplified offsets are created by rounding the optimized offsets given in Table 1.

TABLE 2

| | Space | | | | | | |
|---|---|---|---|---|---|---|---|
| Mark | 2 | 3 | 4 | 5 | 6 | 7 | 8 |
| 2 | 0.000 | 0.065 | −0.025 | −0.025 | 0.000 | 0.000 | 0.000 |
| 3 | −0.065 | 0.000 | −0.095 | −0.095 | −0.075 | −0.075 | −0.075 |
| 4 | 0.025 | 0.095 | 0.000 | 0.000 | 0.020 | 0.020 | 0.020 |
| 5 | 0.025 | 0.095 | 0.000 | 0.000 | 0.020 | 0.020 | 0.020 |
| 6 | 0.000 | 0.075 | −0.020 | −0.020 | 0.000 | 0.000 | 0.000 |
| 7 | 0.000 | 0.075 | −0.020 | −0.020 | 0.000 | 0.000 | 0.000 |
| 8 | 0.000 | 0.075 | −0.020 | −0.020 | 0.000 | 0.000 | 0.000 |

FIG. 10 is a graph showing simulated read-out percentage error of an optical record carrier comprising a sequence of marks and spaces in accordance with the second embodiment of the invention. Simplified offsets as shown in Table 2 have been incorporated between the symbols, and the read-out percentage error in comparison to input data is plotted against nominal length. Marks and spaces are plotted separately. Error fluctuates between +1 and −1% for nominal lengths up to 6 for both marks and spaces.

It can be seen that, although the read-out percentage error is not reduced as strongly as for the simulated carrier with optimized offsets as plotted in FIG. 8, there is a significant reduction in error in comparison with FIG. 4. The read-out percentage error is reduced to around +2 to −3% for nominal lengths up to 6, and in particular, error at nominal length 3 is about −1.5% for spaces and just over 1% for marks. The read-out error can therefore be reduced appreciably even with non-optimized offsets.

Running a simulation of an optical record carrier incorporating marks and spaces with the simplified offsets yields a data to clock jitter of 4.3%. This is not as great a reduction in error as for a simulated carrier incorporating the optimized offsets, but is nonetheless an appreciable reduction in error in comparison with a carrier which does not incorporate any offsets. The simplified offsets in accordance with the second embodiment of the invention have the advantage of being easier to incorporate into an optical record carrier, because they can be manufactured at higher tolerances than the optimized offsets.

FIG. 11 illustrates a method of manufacturing an optical record carrier having the above-described advantages, according to an embodiment of the invention. The manufacture of an optical record carrier involves a mastering process, in which data is written from an initial recording to a record carrier. In the mastering process, a stream of binary data is written to a master memory device such as a master tape (not shown). In known optical record carrier manufacturing methods, binary data is written directly from source to a master tape. The binary data on the master tape is then used to determine the physical positions and dimension of symbols in the data storage layer of an optical record carrier.

In a method according to an embodiment of the present invention, the binary data is processed before writing to the master tape. The processing may take the form of analyzing each piece of data that encodes a symbol, determining the length of the encoded symbol, and amending the symbol-encoding data to incorporate an offset in its length. The offset may be determined with reference to a look-up table, similar to that shown for example in Table 1 or Table 2 above.

The stream of processed binary data on the master tape is used to control a UV light beam projector 80, which projects a UV beam at a layer of UV-sensitive lacquer 84. UV-sensitive lacquer 84 is overlaid on a layer 86, made of, for example, glass. The binary data on the master tape is thereby written into the UV-sensitive lacquer 84. The lacquer is then ‘developed’ by washing with, for example, a sodium hydroxide solution to remove the areas of the UV-sensitive lacquer 84 that have been exposed to the UV light beam, forming an initial relief structure 90. The initial relief structure 90 is then electroplated and at least one metal negative of the relief structure is taken, to form stamper 92, which is also termed the ‘master’. Several stampers may be made. Molten polycarbonate 94 is stamped with stamper 92 to form data storage layer 96. After the data storage layer 96 has cooled and set, it is sputtered with molten aluminum to form the reflective side 98 of the data storage layer. The other layers around the data storage layer are then added; for example, as shown, transparent layer 98 is added by spin-coating.

This method may be used for the manufacture of BD-ROs. In this case, the layer 86 and UV sensitive lacquer 84 would form a portion of a circular disc. The disc is rotated as the UV beam moves across the surface of the UV sensitive lacquer from the center of the disc to the edge, thereby forming the relief structure as a spiral data track after the lacquer is developed. The circular disc incorporating the spiral data track is electroplated, and a circular stamper for the manufacture of BD-ROs is then taken from the circular disc. The circular stamper is then used to make record carriers as described above.

In an alternative embodiment, the processing may take place after the binary data has been written to the master tape, but before the data is physically written to any record carrier.

The above embodiments are to be understood as illustrative examples of the invention. Further embodiments of the invention are envisaged. For example, although the above embodiments relate to BD-ROs, the invention could be applied equally to any optical carrier, which comprises a data storage layer with a relief structure, such as a CD, DVD, etc.

Note that, whilst according to the scheme set out in the embodiments described above, the offset is determined only by the nominal lengths of each symbol adjacent the respective edge, in a further embodiment at least on of the offsets in the scheme may be determined in dependence further on the nominal length of at least one further symbol adjacent a symbol directly adjacent to the edge.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A record carrier, the record carrier comprising a data storage layer including a relief structure for storing data to be read, wherein the relief structure comprises a data track (110) encoding data which is read-only, the data track comprising:
a sequence of symbols having nominal lengths corresponding to an integral multiple of a standard bit length (Δx_{clck}), the symbols having edges positioned according to a set of reference points (112) which are regularly spaced along the data track and separated by the standard bit length (Δx_{clck}),
wherein the data track includes a first such edge (116A), wherein the first edge is shifted along the data track, with respect to one of said reference points, by a first offset (120),
wherein the data track includes a second such edge (124A), wherein the second edge is shifted along the data track, with respect to another of said reference points, by a second offset (126),
wherein the magnitude of the second offset (126) is different to the magnitude of the first offset (120).

2. The record carrier of claim 1, wherein the data track includes a symbol having a centrepoint (124C) halfway between the edges of the symbol, wherein the centrepoint is shifted along the data track, with respect to a reference centrepoint (127) halfway between two of said reference points, by an offset (129).

3. The record carrier of claim 1, wherein the data track includes a first symbol and a second symbol,
the first symbol having a first nominal length (116N), the first nominal length corresponding to a first integral multiple (n₁) of the standard bit length (Δx_{clck}),
the second symbol having a second nominal length, the second nominal length corresponding to a second, different, integral multiple (n₂) of the standard bit length (Δx_{clck}),
wherein said first symbol includes said first edge and wherein said second symbol includes said second edge.

4. The record carrier of claim 3, wherein the second symbol has a third such edge (124B) which is shifted with respect to one of said reference points, by a third offset (128).

5. The record carrier of claim 4, wherein the magnitude of the second offset (126) is different to the magnitude of the third offset (128).

6. The record carrier of claim 3, wherein the data track comprises a third symbol having the same nominal length as the second symbol,
wherein the third symbol has a fourth such edge (134A) and wherein the fourth edge is shifted, with respect to one of said reference points, by a fourth offset (132), the magnitude of which is different to the magnitude of the second offset (126).

7. The record carrier of claim 6, wherein the second symbol is separated from a fourth symbol (118) by said second edge and the third symbol is separated from a fifth symbol (130) by said fourth edge, the fourth symbol and the fifth symbol having different nominal lengths (118N, 130N).

8. The record carrier claim 7, wherein the second integral multiple (n₂) is 3.

9. The record carrier of claim 1, wherein magnitude of the second offset (126) is between 5% and 15% of the standard bit length (Δx_{clck}).

10. The record carrier of either of claim 8 wherein the fourth symbol (118) has a nominal length (118N) of 2.

11. A method of manufacturing a record carrier comprising a data storage layer, the method comprising:
writing digital data to a surface, the writing comprising forming a data track including a sequence of symbols having nominal lengths corresponding to an integral multiple of a standard bit length (ΔX_{clck}), the symbols having edges positioned according to a set of reference points (112) which are regularly spaced along the data track and separated by the standard bit length (Δx_{clck}),
wherein the sequence of symbols includes a first such edge (116A), wherein the first edge is shifted along the data track, with respect to one of said reference points, by a first offset (120),
wherein the data track includes a second such edge (124A), wherein the second edge is shifted along the data track, with respect to another of said reference points, by a second offset (126),
wherein the magnitude of the second offset (126) is different to the magnitude of the first offset (120).

12. The method of claim 11, wherein the first offset (120) and the second offset (126) are determined with reference to a look-up table.
